(19) United States
(12) Patent Application Publication
(10) Pub. No.: US 2015/0332608 A1
(43) Pub. Date: Nov. 19, 2015

(54) LASER DAZZLE EVALUATION

(71) Applicant: THE SECRETARY OF STATE FOR DEFENCE, Salisbury, Wiltshire (GB)

(72) Inventor: CRAIG WILLIAMSON, SALISBURY (GB)

(21) Appl. No.: 14/655,657

(22) PCT Filed: Jan. 15, 2014
(86) PCT No.: PCT/GB2014/000010

§ 371 Date: Jun. 25, 2015

(30) Foreign Application Priority Data
Jan. 15, 2013 (GB) 1300696.0

(51) Int. Cl. G09B 23/22; H04N 5/232; G06T 3/40; H04N 5/225; H04N 9/04

(52) U.S. Cl. CPC G09B 23/22; H04N 5/2252; H04N 9/045; G06T 3/4015; H04N 5/23293; G06T 2207/10016; G06T 2207/20221; G06T 2207/30196; G06T 2210/61

(57) ABSTRACT

There is provided a laser dazzle simulator system, comprising a video camera (20), a processor (50), and a display (60). The processor (50) is configured to receive video of a scene from the video camera (20); superimpose an influence of a laser (LSR) upon the video to simulate a view of the scene that a human would see if the human was viewing the scene whilst having the laser directed into their eyes; and output the simulated view to the display.

### TECHNICAL FIELD OF THE INVENTION

The invention relates to evaluation of laser dazzle, and in particular to evaluating the amount of dazzle that a human experiences from a laser source.

### BACKGROUND TO THE INVENTION

Laser sources are becoming more and more technologically developed, and new application areas such as the use of lasers for crowd control are being explored. The unauthorised use of lasers is also a growing problem, with civilian and military aircraft increasingly being targeted by high power laser pointers, which can cause a visual distraction to pilots with the potential to cause mass fatalities.

There is a need to evaluate the impact that lasers have upon humans, in particular the visual dazzling effects that may be experienced as a result of being exposed to any given laser in a given set of ambient environmental conditions.

The evaluation of laser dazzle is typically carried out using human subjects, although stringent requirements need to be met for minimising the level of risk to the human subjects, and tests are often expensive and limited in number and in scope. Laser dazzle may also be referred to as laser glare.

It is therefore an aim of the invention to improve upon the known art.

### SUMMARY OF THE INVENTION

According to a first aspect of the invention, there is provided a laser dazzle simulator system, comprising a video camera, a processor, and a display, wherein the processor is configured to receive video of a scene from the video camera; superimpose an influence of a laser upon the video to simulate a view of the scene that a human would see if the human was viewing the scene whilst having the laser directed into their eyes; and output the simulated view to the display.

The laser dazzle simulator system enables real-world tests to be carried out on video to help assess the impact of a laser upon the view that a person sees of a scene, without the person actually needing to view the laser. The use of video that is displayed on the display with the simulated influence of the laser may enable an operator to view both the scene and the display at the same time, so that the operator can compare their view of the scene with their view of the display, to better appreciate what their view of the scene would be if they were to view the scene with the laser being shined into their eyes.

The system may further comprise a laser source configured to emit the laser, and a laser intensity detector configured to detect at least an intensity of the laser at the video camera. The processor may be configured to superimpose the influence of the laser upon the live video based upon the detected intensity of the laser. Accordingly, tests may be carried out with real laser sources so that the effects of atmospheric attenuation and scatter upon the laser between the laser source and the laser intensity detector do not have to be modelled but are true-to-life.

The laser intensity detector may be configured to detect a colour of the laser, and the processor may be configured to superimpose the influence of the laser upon the live video based upon the detected colour of the laser. Preferably, the processor is configured to increase the superimposed influence of the laser upon the video in response to an increase in the detected intensity of the laser.

Advantageously, the system may further comprise an ambient light detector, wherein the ambient light detector is configured to detect at least an intensity of ambient light at the video camera. The processor may be configured to superimpose the influence of the laser upon the live video based upon the detected intensity of the ambient light. Accordingly, the influence of the laser may be applied more strongly to the live video from the video camera if the video is being taken under low-light conditions.

Furthermore, the ambient light detector may be configured to detect a colour temperature of the ambient light; and the processor may be configured to superimpose the influence of the laser upon the live video based upon the detected colour temperature of the ambient light. Therefore the accuracy of the colours in the scene relative to the colour of the laser light may be increased, for example to improve the simulation of how well particular colours would be distinguishable from one another by a human when viewing the scene with the laser being shined into their eyes.

To avoid the laser from interfering with the view of the scene taken by the video camera, the laser source may be directed to shine at the laser intensity detector but not the video camera lens. Alternatively, the video camera may have a high dynamic range so that the laser does not dazzle the video camera, and/or the video camera may be equipped with a filter to filter out the wavelength of the laser light.

The processor may be programmable with the age and eye colour of the human to improve the simulation of the view of the scene the human would see when the laser was shined into their eyes. The processor may be configured to superimpose the influence of the laser upon the live video according to the Stiles-Holladay relation for simulating human vision glare effects. The Stiles-Holladay relation is L_{eq}=10E_{glare}/θ², wherein L_{eq} is the equivalent veiling background in cd/m2, E_{glare} is the illuminance of the glare source at the eye measured in lux, and θ is the angular distance between the line of sight and the glare source in degrees, as is known to those skilled in the arts. The above-mentioned processing according to the Stiles-Holladay relation is considered to cover processing that is in accordance with the Stiles-Holladay relation, for example the age-adjusted Stiles-Holladay relation.

Advantageously, the system may further comprise a user interface for programming an intensity and a wavelength of the laser into the processor, for example for if the laser is to be simulated rather than actually generated by a laser source. The user interface may also allow programming of the ambient light intensity and the atmospheric conditions to assist the simulation of the laser and the effect that it has upon the video. For example, an atmospheric condition may be “fog”, or may be a visibility distance. The user interface may additionally or alternatively allow programming of factors such as the presence of vehicle windscreens, or spectacles that are being worn by the human being'simulated, in particular to take into account the refractive and/or scattering effects of such objects.

Preferably, the video received from the video camera is live video, providing instant flexibility in the scene that is being recorded, and almost immediate feedback on the display of what the scene would look like to a human viewing the scene with the laser being shined into their eyes. Accordingly, an improved evaluation of laser dazzle can be carried out compared to simply simulating glare on pre-recorded video or photographs. Live video is video that has only just been recorded a negligible amount of time ago, for example less than 5 minutes ago, preferably less than 30 seconds ago, and more preferably less than 5 seconds ago.

Advantageously, the laser dazzle simulator system may be arranged as a single physical structure, rather than distributed between various different locations. For example, the various parts of the laser dazzle simulator system may all be physically connected to one another at the same location, except for the laser source if included in the system. Then, the laser dazzle simulator system provides a device which can be used to perform laser tests and give immediate feedback to an operator of the device, allowing laser tests to be immediately modified and run again dependent upon the results. Alternatively, immediate feedback may be provided via a communication network, for example if the video camera is used outdoors and the display and optionally the processor are located indoors.

The single physical structure may be disassembled for transportation, and may for example include a support framework for supporting the various parts of the system.

According to a second aspect of the invention, there is provided a method of simulating laser dazzle, comprising:
receiving video of a scene from the video camera,
superimposing an influence of a laser upon the video to simulate a view of the scene that a human would see if the human was viewing the scene whilst having the laser directed into their eyes;
outputting the simulated view to the display.

### BRIEF DESCRIPTION OF THE DRAWINGS

Embodiments of the invention will now be described by way of example only and with reference to the accompanying drawings, in which:

FIG. 1 shows a schematic diagram of a laser dazzle simulator system according to an embodiment of the invention;

FIG. 2 shows a display of the laser dazzle simulator system of FIG. 1, the display showing a view of a scene; and

FIG. 3 shows the display of FIG. 3, the display showing a view of the scene with simulated laser dazzle.

FIG. 4 shows a flow diagram of a method used in the laser dazzle simulator system of FIG. 1.

The drawings are for illustrative purposes only and are not to scale.

### DETAILED DESCRIPTION

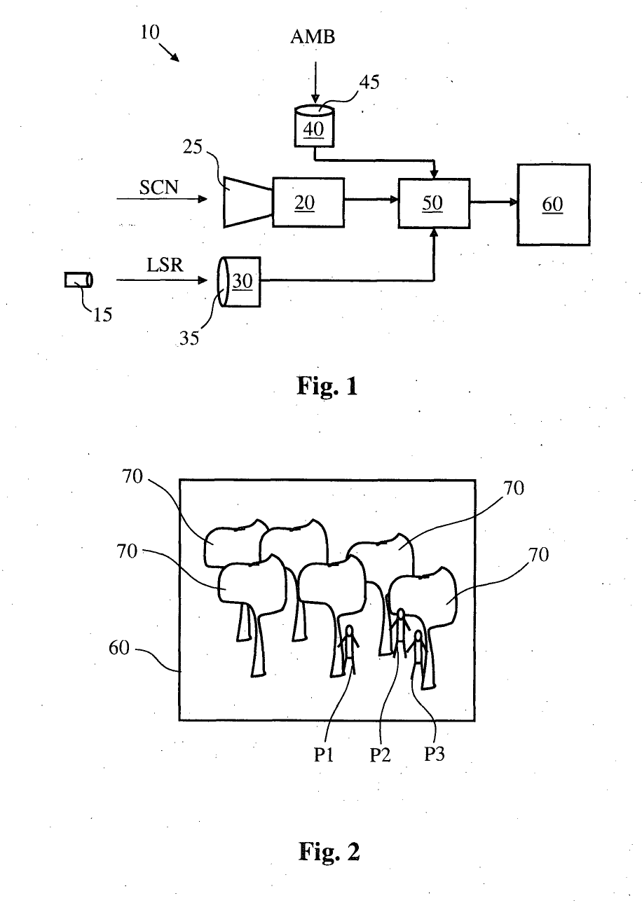

An embodiment of the invention will now be described with reference to the schematic diagram of FIG. 1, which shows a laser dazzle simulator system 10 comprising a video camera 20, a processor 50, and a display 60. In this particular embodiment, the video camera 20 is a standard consumer-level video camera, the processor 50 is a general-purpose computer, and the display 60 is a computer monitor. The video camera 20 comprises a lens 25 for focussing light SCN from a scene being recorded by the camera, and sends, live video of the scene to the computer 50 via a cable, for example an HDMI cable.

The laser dazzle simulator system 10 further comprises a laser intensity detector 30 with a lens 35 for receiving laser light LSR, and an ambient light level detector 40 with a lens 45 for receiving ambient light AMB. The laser light LSR is generated by a laser source 15 that also forms part of the laser dazzle simulator system 10. Optionally, the lenses 35 and/or 45 may be omitted depending on the types of detectors 30, 40 that are used.

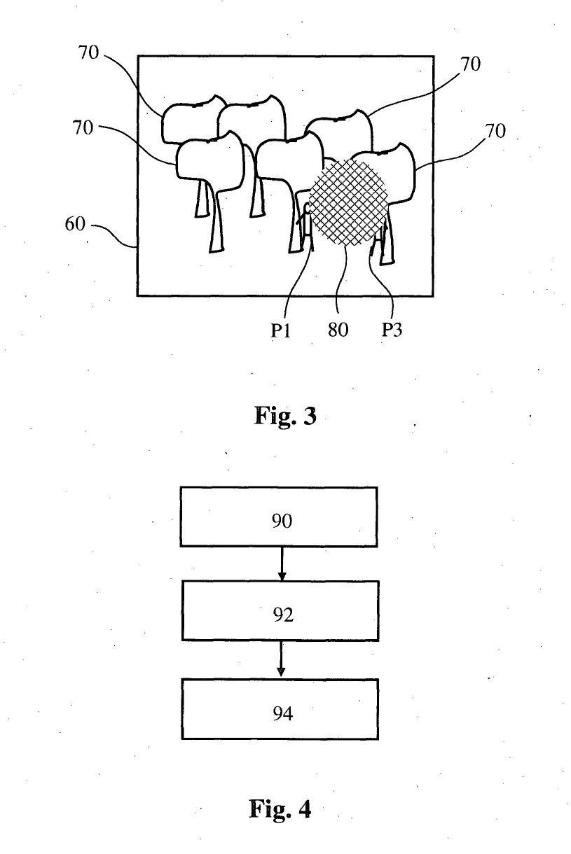

The various parts 20, 30, 40, 50, 60 of the system 10 are all physically connected to one another and so form a single physical structure. The use of the laser dazzle simulator system 10 will now be described with reference to FIGS. 2 and 3, which show the display 60 when displaying live video of a scene being recorded by the video camera.

The scene comprises three people P1, P2, and P3 standing amongst a group of trees 70. A view of the scene is recorded by the video camera 20, and sent to the processor 50 as video. The processor 50 also receives the ambient light level and ambient light colour temperature from the ambient light level detector 40. The processor 50 processes the video from the video camera 20 according to the ambient light, and sends the processed video to the display 60 as shown in FIG. 2. The display 60 is fitted with a hood (not shown in Figs) to shield the displayed view from ambient light, and to allow an operator to see the displayed view in darkness so that the operator's perception of the displayed view is not significantly affected by the ambient light conditions. The operator may move between looking at the display 60 and looking directly at the scene to check that their view of scene is visually the same as their view of the display, in particular that the brightness and colour contrast are the same. A user interface provided at the processor 50 may be used to adjust the brightness and/or contrast of the processed video so that the operator's view of the display matches the operator's view of the scene.

One of the people P2 is then provided with the laser source 15, and is instructed to direct a laser from the laser source towards the laser intensity detector 30. The laser intensity detector 30 receives the laser and informs the processor 50 of the intensity and colour (wavelength) of the laser light, and the processor 50 superimposes laser dazzle (glare) 80 upon the view of the scene taken by the video camera 20, as shown in FIG. 3. The laser dazzle in superimposed upon the video according to the relative colours and intensities of the ambient light and the laser light, and any brightness/contrast adjustments previously specified by the operator.

For simplicity the laser dazzle 80 is shown on FIG. 3 as covering a discrete spot around the person P2, although clearly in reality the intensity of the laser dazzle 80 will continuously varying outwards from the centre of the laser spot according to the laser dazzle simulation relation that is used.

The operator can view the display 60 to see how the laser dazzle affects the view that can be seen, for example whether it is still possible to discern the people P1 and P3, or whether the laser dazzle has obscured the people P1 and P3, or has reduced the contrast between the trees 70 and the people P1 and P3 so much that the people P1 and. P3 could not easily be seen.

Following the flow diagram of FIG. 4, the processor receives 90 video of the scene having the trees 70 and people P1-P3, superimposes 92 the influence of the laser from the laser source 15 upon the video of the scene, to simulate a view of the scene that a human would see if the human was viewing the scene whilst having the laser directed into their eyes, and outputs 94 the simulated view to the display 60.

The operator may be equipped with protective glasses for when the laser is shined towards the laser intensity detector 30, to help protect the operator in the case that the laser is mis-directed, or if the laser is being shone from such a distance away that the laser spot spreads to cover a large area including both the laser intensity detector 30 and the operator. Clearly the protective glasses should be removed whilst the operator views the display 60 within the hood, to avoid the operator from seeing a colour-distorted view of the display 60. If the laser spot spreads to cover the video camera 20 then the video camera lens 25 may be fitted with a filter to help stop the laser light from entering the video camera and distorting the view of the scene.

One example of how the video from the camera 20 can be modified with simulated laser dazzle, will now be explained with reference to a function based upon the CIE 2002:146 General Disability Glare equation, which is in accordance with the Stiles-Holladay relation.

The function is implemented within the processor 50, and takes as inputs an image to which the laser dazzle is to be applied, the horizontal field of view covered by the image, the age of the human to be simulated, the eye pigmentation of the human to be simulated, the eye's photopic response at the wavelength of the laser, the intensity of the laser at the eye, the ambient light level, and the position of the laser within the image.

The user interface at the processor 50 may be used to set the age and eye pigmentation of the human to be simulated, and optionally other ones of the parameters such as the position of the laser within the image and the field of view covered by the image. Alternatively, one or more of the parameters may be permanently fixed.

Firstly, the function determines the viewing angle covered by each pixel based upon the number of pixels in the image and the horizontal field of view covered by the image. Then, based upon the position of the laser within the image, the function determines the viewing angle θ between the centre position of the laser and each pixel.

The amount of veiling luminance produced by the laser is equal to the amount of scattering multiplied by the illumination. The scattering is calculated as (10/θ³+(((5/θ²)+(0.1*pigm)/θ)*(1+((age/62.5)⁴)))+(0.0025*pigm), wherein age is the age of the human being simulated and wherein pigm is set as 0 for black eyes, 0.5 for brown eyes, 1.0 for light eyes, and 1.2 for very light eyes. The illumination is calculated as 683 * the eye's photopic response at the laser wavelength * the irradiance (power per unit area, i.e. intensity) of the laser at the eye. The above factor of 683 for calculating luminance is taken from the document “Photometry—The CIE system of physical photometry”, International Standard ISO 23539:2005(E) CIE S 010/E:2004 First Edition, 2005.

Once the veiling luminance has been calculated for each pixel, the amount of dazzle for each pixel is calculated based upon the ratio between the veiling luminance and the ambient light level. In this example, if the veiling luminance is 100 times greater than the ambient light level then the laser light is considered to obliterate any detail in the ambient light and the pixel is set with maximum luminance at the same colour as the laser light, if the veiling luminance is 100 times less than the ambient light then the colour and luminance of the pixel is unchanged, and ratios in between these are set to linearly move the pixel colour and luminance towards the laser light colour and maximum luminance.

The above function is typically applied to each video frame of the video, to produce processed video for displaying on the display 60. Further changes to the video may also be specified by the operator, for example via the user interface. The factor of 100 used above is arbitrary, and may be changed as required. For example, higher number factors may be used to represent higher dynamic range of the eye.

In an alternate embodiment, the laser intensity detector 30 may detect laser intensity but not colour, and the colour of the laser may be programmed into the user interface of processor 50.

Although the specific examples of FIGS. 1-4 incorporate a real laser from the laser source 15, the system could be simplified by inputting values for the laser wavelength and intensity into the user interface of processor 50, rather than by using a real laser, although the results are unlikely to be as accurate.

The hood that is fitted to the display 60 may be omitted if the display is mounted inside a building where lighting conditions are more easily controlled than outside.

The term “record” in the context of the video camera does not imply any long-term storage of the video, but instead simply refers to the process of generating an electronic representation of what the scene looks like.

Further embodiments falling within the scope of the appended claims will also be apparent to those skilled in the art. For example, the video camera 20 could be replaced with a more advanced video camera like a low-light Electron-Multiplied CCD (EMCCD) camera, or a high dynamic range ‘lin-log’ camera, or a high-end 3-chip CCD camera, to help provide more accurate results for low light level tests. Furthermore, the monitor 60 could be replaced with a high dynamic range monitor, particularly if a high dynamic range camera was used.

While the Stiles-Holladay relationship may be used to superimpose the influence of the laser, any variation on that equation may be used as an alternative. For example an empirical equation or part-empirical equation may be used as an alternative to or in conjunction with the Stiles-Holladay relationship.

The above techniques of simulating laser dazzle may be applied equally to the creation of static images representing the effect of a laser on vision of a static scene. In this embodiment a static image may be loaded and laser and ambient light parameters (and optionally additional parameters) may be entered to give an estimated dazzle spot on that static image. Further, a real laser could be detected along with real ambient light levels, and then the resulting dazzle spot could be applied to the static image. Such images can be viewed by means of a software application itself and visual display, or can be saved to a data storage medium. Images of estimated laser eye dazzle effects may be combined to form a catalogue. Such images may be used in conjunction with the above described videos, for example with each stored video being electronically reference-able from a respective static image in a catalogue (for example by selecting the respective image within an electronic catalogue).

Accordingly there may be provided a laser dazzle simulator system, comprising a processor, and a display, wherein the processor is configured to:—receive image data of a scene;—superimpose an influence of a laser upon the image data to simulate a view of the scene that a human would see if the human was viewing the scene whilst having the laser directed into their eyes; and—output the simulated view to the display in the form of a static image. Optionally the laser dazzle simulator system comprises a camera and the step of receiving image data of a scene from a camera includes the step of recording image data of a scene using the camera. Optionally the static image is received from a camera. Optionally the camera is a static image camera (in which case optionally the image has a file size of or equivalent to at least 10 megapixels). Optionally the camera is a video camera (in which case optionally the video refresh rate is at least 20 frames per second). As a further alternative the image data of a scene may be a digitally generated image based on a computer simulation of a scene, and the camera may be a virtual camera. Such a computer simulation of a scene may be generated using video game technology as is known in the art. Typically however the camera is a physical camera and the image data is of a physical scene rather than a computer generated one.

1. A laser dazzle simulator system, comprising a video camera, a processor, and a display, wherein the processor is configured to:
receive video of a scene from the video camera;
superimpose an influence of a laser upon the video to simulate a view of the scene that a human would see if the human was viewing the scene whilst having the laser directed into their eyes; and
output the simulated view to the display,
wherein the laser dazzle simulator system is arranged as a single physical structure.

2. The system of claim 1, further comprising a laser source configured to emit the laser, and a laser intensity detector configured to detect at least an intensity of the laser at the video camera; wherein the processor is configured to superimpose the influence of the laser upon the video based upon the detected intensity of the laser.

3. The system of claim 2, wherein the laser intensity detector is further configured to detect a colour of the laser; and wherein the processor is configured to superimpose the influence of the laser upon the video based upon the detected colour of the laser.

4. The system of claim 2, wherein the processor is configured to increase the superimposed influence of the laser upon the video in response to an increase in the detected intensity of the laser.

5. The system of claim 1, further comprising an ambient light detector, wherein the ambient light detector is configured to detect at least an intensity of ambient light at the video camera; and wherein the processor is configured to superimpose the influence of the laser upon the video based upon the detected intensity of the ambient light.

6. The system of claim 5, wherein the ambient light detector is further configured to detect a colour temperature of the ambient light; and wherein the processor is configured to superimpose the influence of the laser upon the video based upon the detected colour temperature of the ambient light.

7. The system of claim 5, wherein the processor is configured to increase the superimposed influence of the laser upon the video in response to a decrease in the detected intensity of the ambient light.

8. The system of claim 1, further comprising a filter for the video camera, the filter configured to filter out the laser to block the laser from being recorded by the video camera.

9. The system of claim 1, wherein the processor is programmable with the age and eye colour of the human.

10. The system of claim 1, wherein the processor is configured to superimpose the influence of the laser upon the video according to the Stiles-Holladay relation.

11. The system of claim 1, further comprising a user interface configured to program into the processor at least one of an intensity of the laser, a wavelength of the laser, an ambient light level, and an atmospheric condition.

12. The system of claim 1, further comprising a hood that shields the display from ambient light so an operator can view the display in darkness.

13. The system of claim 1, wherein the video received from the video camera is live video that was recorded no more than 30 seconds ago.

14. (canceled)

15. A method of simulating laser dazzle, comprising:
receiving video of a scene from the video camera,
superimposing an influence of a laser upon the video to simulate a view of the scene that a human would see if the human was viewing the scene whilst having the laser directed into their eyes;
outputting the simulated view to a display,
wherein the video camera and the display are arranged as a single physical structure.

16. (canceled)
